(19) United States
(12) Patent Application Publication
(10) Pub. No.: US 2026/0104673 A1
(43) Pub. Date: Apr. 16, 2026

(54) ROTATING BEZEL TIMER WATCH WITH MAGNETIC SENSING

(71) Applicant: Sebastian Bruno Coley Murga, Miami Beach, FL (US)

(72) Inventor: Sebastian Bruno Coley Murga, Miami Beach, FL (US)

(21) Appl. No.: 19/350,781

(22) Filed: Oct. 6, 2025

Related U.S. Application Data
(60) Provisional application No. 63/706,378, filed on Oct. 11, 2024.

(51) Int. Cl. G04F 3/08; G01D 5/14; G04C 10/00

(52) U.S. Cl. CPC G04F 3/08; G01D 5/142; G04C 10/00

(57) ABSTRACT

The present disclosure provides a timekeeping device comprising a rotatable bezel including a reference marker, a watch time-indicating element including a second reference marker, a sensor array comprising a plurality of hall-effect sensors disposed radially beneath a dial, a microcontroller configured to interpret relative positions of the bezel and minute hand, and an alarm actuator configured to trigger upon alignment of the bezel reference and the minute hand. The microcontroller includes an analog-to-digital converter and multiplexer for sequential activation of the hall-effect sensors. The sensor array comprises a position-detection subsystem configured to determine, directly or indirectly, a relative angular position between said reference marker and said second reference marker. The alarm actuator comprises a piezoelectric transducer configured to produce both audible tones and haptic vibration simultaneously when the predetermined alignment condition occurs between the magnetic markers.

### CROSS-REFERENCE TO RELATED APPLICATIONS

“This application claims the benefit of U.S. Provisional Patent Application No. 63/706,378, filed on Oct. 11, 2024, which is incorporated by reference herein in its entirety

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates in general to timekeeping devices with alarm and timer functionality, and more particularly to a wristwatch or timekeeping device.

### 2) Description of Related Art

Currently the state of the art includes a variety of electronic timepiece that provide the user with time information, GPS locations and various timers and alarms. However, they are difficult to use and set.

Timekeeping devices have evolved considerably over the centuries, from mechanical pocket watches to modern digital smartwatches. Traditional wristwatches or timekeeping devices primarily serve the function of displaying current time, though many incorporate additional features such as alarms, stopwatches, and countdown timers. These supplementary timing functions have become increasingly valuable as individuals seek to manage various time-sensitive activities throughout their daily routines.

Conventional alarm and timer systems in wristwatches or time keeping devices typically rely on mechanical crown adjustments or digital button-based interfaces for user input. Mechanical systems often involve rotating crowns through multiple positions and making fine adjustments to set desired alarm times. Digital systems generally require users to navigate through menu structures using push buttons, cycling through hours, minutes, and various timing modes. While functional, these approaches can present challenges in terms of user convenience and intuitive operation.

The process of setting short-duration timers, particularly those lasting minutes rather than hours, often involves multiple steps and can interrupt the user's workflow. For applications requiring frequent timer adjustments, such as timing brief intervals during work tasks, cooking activities, or exercise routines, the complexity of existing interfaces may discourage regular use of these timing features.

Modern electronic timekeeping devices have incorporated various sensing technologies to enhance functionality and user interaction. Magnetic sensing, optical detection, and capacitive touch systems have been employed in different contexts to provide alternative input methods and improve device responsiveness. These technologies offer potential advantages in terms of reliability, power consumption, and integration within compact device housings.

The integration of microcontroller technology in timekeeping devices has enabled more sophisticated timing functions while maintaining compact form factors suitable for wearable applications. Low-power microcontrollers can manage complex timing algorithms, sensor data processing, and user interface functions while operating within the power constraints of power systems commonly used in wristwatches or time keeping devices. However, these devices involve complex procedures to implement simple timing applications.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide timekeeping device that provides the user a simple to use and reliable timer function.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a timekeeping device is provided. The timekeeping device may comprise of a rotatable bezel including a magnetic reference marker. The timekeeping device comprises a watch with a reference indicator such as a minute hand including a miniature magnetic marker. The timekeeping device comprises a sensor array comprising a plurality of hall-effect sensors disposed radially beneath a dial. The timekeeping device comprises a microcontroller configured to interpret relative positions of said bezel and minute hand. The timekeeping device comprises an alarm actuator configured to trigger upon alignment of the bezel reference and the minute hand. However, the applicant envisions other embodiments that use capacitive, optical, encoder-based, or other sensing methods for detecting a relative angular position between a rotatable bezel reference marker and a time-indicating element reference marker.

According to other aspects of the present disclosure, the timekeeping device may include one or more of the following features.

The microcontroller may operate in a low-power deep-sleep mode between sensor readings. The sensor array may comprise twelve hall-effect sensors on a flexible printed circuit board. The alarm actuator may be a piezoelectric transducer. The alarm actuator may be a vibration motor. The microcontroller may further comprise an analog-to-digital converter and multiplexer for sequential activation of the hall-effect sensors. Rotating the bezel may set a countdown timer for up to 59 minutes. The system may further comprise wireless synchronization capability. The timekeeping device may be integrated into a wristwatch or time keeping devices enclosure. The bezel may include multiple magnets distributed along its circumference to provide higher resolution detection. The sensor array may further comprise optical or magnetic-field gradient sensors as alternatives to hall-effect sensors. The watch may have an analog display synchronized with the bezel-controlled timer. The microcontroller may be further configured to transmit timing information via Bluetooth Low Energy to an external smart device. The alarm actuator may be configured to produce both audible tones and haptic vibration simultaneously. The bezel may further include detents or tactile clicks corresponding to discrete minute increments. The MCU firmware may be updatable via wireless interface. The watch case may be water-resistant and adapted to house the sensor array without signal interference. The countdown timer may be paused and resumed by a secondary bezel rotation gesture. Alternatively, the countdown timer could count down minutes by rotating in one direction or count town seconds by rotating to the opposite side

The alarm actuator may further comprise a light-emitting diode (LED) visual indicator. The external smart device may display the timer and the watch information such as time and timer status. However, in an alternative embodiment the bezel rotation could be replaced by user input interface such as crown, capacitive touch ring, or touchscreen slider.

The foregoing general description of the illustrative embodiments and the following detailed description thereof are merely exemplary aspects of the teachings of this disclosure and are not restrictive.

Still other objects and advantages of the invention will in part be obvious and will in part be apparent from the specification.

The above and other objects, which will be apparent to those skilled in the art, are achieved in the present invention, which is directed to a timekeeping device, comprising:
a. a rotatable bezel including a reference marker;
b. a time-indicating element including a second reference marker;
c. a sensor array comprising a position-detection subsystem configured to determine, directly or indirectly, a relative angular position between said reference marker and said second reference marker such as a plurality of hall-effect sensors disposed radially beneath a dial;
d. a controller configured to interpret said relative angular position to establish a countdown timer and to trigger a notification when the countdown timer expires; and
e. a notification subsystem configured to provide a user notification upon expiration of the countdown timer such as an alarm actuator configured to trigger upon alignment of the bezel reference and the minute hand.

The time keeping system could be replaced with a digital countdown display with a bezel marker and therefore the system could be implemented with digital indicators such as LEDs, LCDs, electronic displays as alternative time-indicating elements. Alternatively, the device could be capacitive, or can be that the microcontroller could know the time and counts the clicks of the bezel rotating about face of device.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a perspective view of a rotating bezel timer watch assembly, according to aspects of the present disclosure.

FIG. 2 illustrates a cross-sectional view of the watch assembly of FIG. 1 showing bezel magnets and hall-effect sensor array placement, according to an embodiment.

FIG. 3 illustrates a block diagram architecture showing an operational sequence of the rotating bezel timer watch, according to aspects of the present disclosure.

FIG. 4 illustrates a circuit schematic overview showing electrical interconnections between components of the bezel timer watch, according to an embodiment.

FIG. 5 shows an exploded view of the watch assembly of FIG. 1, according to aspects of the present disclosure.

FIG. 6 shows a PCB layout for a sensor array configuration, according to an embodiment.

FIG. 7 illustrates schematics of a sensor array flex PCB, according to aspects of the present disclosure.

FIG. 8 illustrates the system architecture.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

When ever a specific component is mentioned in the specification the applicant acknowledges that any suitable device could be substituted for the device specified as long as it is capable of performing the task of the device identified in the specification and therefore the applicant incorporates that substitution capability into the specification by this reference.

As this invention is susceptible to embodiments of many different forms, it is intended that the present disclosure be considered as an example of the principles of the invention and not intended to limit the invention to the specific embodiments shown and described.

Prior to a discussion of the preferred embodiment of the invention, it should be understood that while the features and advantages of the invention are illustrated in terms of a timekeeping device the applicant realizes that the technology has numerous alternative uses including integrating with dive watches, military applications and sports applications and therefore reserves those rights in advance

The following description sets forth exemplary aspects of the present disclosure. It should be recognized, however, that such description is not intended as a limitation on the scope of the present disclosure. Rather, the description also encompasses combinations and modifications to those exemplary aspects described herein.

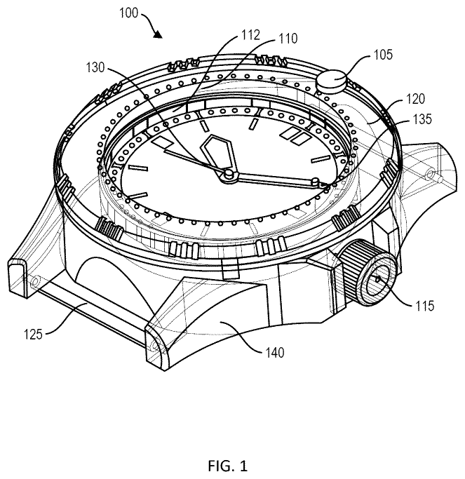

Referring to FIG. 1, a watch assembly 100 represents a timekeeping device that integrates traditional analog watch functionality with advanced magnetic sensing technology to provide timer control through an intuitive bezel interface. The watch assembly 100 incorporates a rotating bezel 120 that serves as the primary user interface for setting countdown timers, eliminating the complexity associated with conventional button-based timer systems. A bezel magnet 105 is embedded within the rotating bezel 120 to provide a magnetic reference point that interacts with sensing components positioned beneath the watch dial. The watch assembly 100 further includes a crown 115 for standard timekeeping adjustments and a spring pin 125 that provides mechanical securing of internal components within the overall structure. However, the disclosure is in the format of a wristwatch and any suitable timekeeping device could be substituted for the wristwatch configuration.

The applicant also envisions other embodiments that use capacitive, optical, encoder-based, or other sensing methods.

In a first embodiment the magnetic sensing system operates through the interaction between the bezel magnet 105 and a hall effect sensor array 110 that detects changes in magnetic field strength and orientation as the rotating bezel 120 moves to different positions. A sensor ring 112 houses the hall effect sensor array 110 in a configuration that allows for precise detection of the bezel magnet 105 position relative to the watch dial. The hall effect sensor array 110 comprises twelve hall-effect sensors arranged radially beneath the dial for detecting bezel and minute hand positions, providing discrete sensing points that correspond to minute increments on the timer interface. The hall effect sensor array 110 is implemented on a flexible printed circuit board to fit inside standard watch enclosures, allowing the sensing components to conform to the curved geometry of the watch case while maintaining electrical connectivity.

The sensor ring 112 houses the hall effect sensor array 110 are protected from environmental contamination by a barrier that can be made from clear materials such as a polycarbonate, glass, crystal or other suitable material that can be sealed to the watch case 140 and rotating bezel 120. Alternatively, a clear or translucent coating could be applied to the sensor ring 112 and seal the area between the watch case 140 and rotating bezel 120. The coating could be made from an ink formulated from Antimony Tin Oxide (ATO) nanoparticles.

In a second preferred embodiment the watch could use either capacitive, optical, encoder-based, or other sensing methods or a position-detection subsystem configured to determine, directly or indirectly, a relative angular position between said reference marker and said second reference marker.

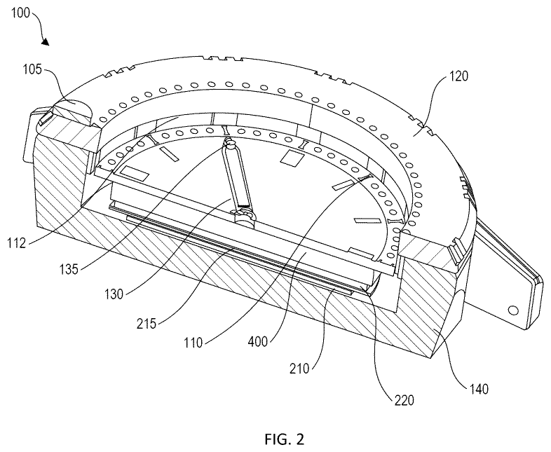

As shown in FIG. 2, the watch assembly 100 incorporates a clock mechanism 130 that drives the standard timekeeping functions while also supporting the timer functionality through magnetic position detection. A minute hand magnet 135 is integrated into the timekeeping mechanism to provide a secondary magnetic reference point that works in conjunction with the bezel magnet 105 to establish timer countdown operations. The interaction between the bezel magnet 105 and the minute hand magnet 135, as detected by the hall effect sensor array 110, enables the system to determine when the countdown timer reaches zero and triggers an alarm condition. A watch case 140 provides structural housing for all components while maintaining the aesthetic appearance of a traditional analog timepiece.

The time keeping system could be replaced with a digital countdown display with a bezel marker and therefore the system could be implemented with digital indicators such as LEDs, LCDs, electronic displays as alternative time-indicating elements.

While some embodiments utilize an analog minute hand as a reference indicator, other embodiments may employ digital or electronic indicators. For example, an LED pointer, LCD or OLED display element, or other electronic visual marker may function as the time-indicating element. The bezel may then be aligned with or compared against the digital indicator to establish and track countdown timing. Such digital implementations may be used independently or in combination with traditional analog indicators.

The electronic control system includes a piezoelectric buzzer 210 that generates audible alerts when timer conditions are met, along with a sensor monitoring board 215 that processes signals from the hall effect sensor array 110. However, in alternative embodiments the system could use any suitable notification system such as audible, haptic, visual, or communication-based alerts and the system could also utilize a communication interface configured to transmit notifications to an external device.

Alternatively, the system could have a position-detection subsystem configured to determine a relative angular position” without requiring magnetic sensing such as capacitive, optical sensing technologies.

A battery 220 powers the entire system, with the battery 220 being a coin-cell battery such as CR1220 to power the system with optimized deep-sleep modes for extended battery life. However, any suitable coin-cell battery or power source configured to supply energy, including coin-cell, rechargeable, solar, energy-harvesting, or wired power could be used. With continued reference to FIG. 2, a control board 400 coordinates the overall system operation by processing sensor data and managing timer functions through integrated electronic components. The piezoelectric buzzer 210 is configured to produce both audible tones and haptic vibration simultaneously, providing multiple forms of user notification when timer events occur.

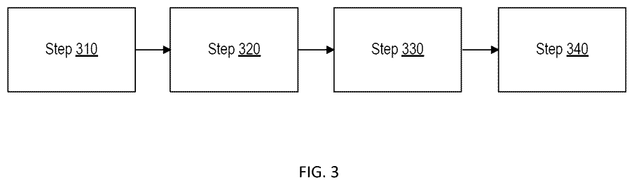

Referring to FIG. 3, the operational sequence demonstrates how user interaction with the rotating bezel 120 initiates a series of electronic processes that culminate in timer activation and alarm generation. The system begins when a user rotates the rotating bezel 120 to a desired timer position, causing the bezel magnet 105 to move relative to the hall effect sensor array 110. The hall effect sensor array 110 uses high-sensitivity, low-power hall sensors such as (TMAG5253BA4IQDMRR) for magnetic field detection, enabling precise position determination while minimizing power consumption. However, any suitable low-power hall sensor could be used. The detected magnetic field changes are processed by electronic components that interpret the bezel position and establish the countdown duration based on the angular displacement of the rotating bezel 120.

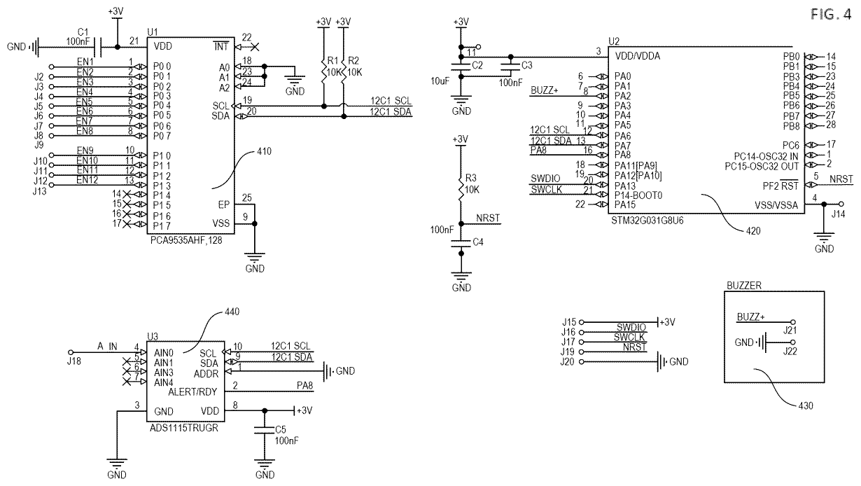

As illustrated in FIG. 4, a microcontroller circuit 420 serves as the central processing unit for the timer system, coordinating sensor data acquisition and alarm activation functions. The microcontroller circuit 420 includes a low-power processor such as ARM Cortex-M0+ processor (STM32G031G8U6) with deep-sleep capability for power optimization, allowing the system to operate efficiently within the power constraints of a wristwatch application. However, any suitable low-power processor could be used. A sensor array 420 represents the collective sensing elements that detect magnetic field variations from both the bezel magnet 105 and the minute hand magnet 135. The control board 400 includes a multiplexer such as the (PCA9535AHF) and analog-to-digital converter such as the (ADS1115IRUGR) for sequential sensor reading and data processing, enabling the microcontroller circuit 420 to efficiently monitor multiple sensor inputs without excessive power consumption. However, any suitable multiplexer or analog-to-digital converter could be used. Alternatively, the system could have a position-detection subsystem configured to determine a relative angular position” without requiring magnetic sensing such as capacitive, optical sensing technologies. Although bezel rotation is described in detail as a primary input interface, alternative input mechanisms may be employed to establish countdown parameters. Examples include a rotating crown, a capacitive touch-sensitive ring, a touch-sensitive bezel, or a touchscreen interface configured to simulate bezel or dial interactions. The input interface may be rotational, linear, or gesture-based, with equivalent control functionality for setting or adjusting timers.

The system architecture supports various alternative configurations and enhanced functionality options that expand the basic timer operation. The watch assembly 100 includes a vibration motor as an alternative alarm actuator to the piezoelectric buzzer 210, providing silent notification options for discrete timer alerts. The rotating bezel 120 includes multiple magnets distributed along its circumference to provide higher resolution detection, enabling more precise timer setting increments beyond the basic twelve-position configuration. The hall effect sensor array 110 alternatively comprises optical or magnetic-field gradient sensors instead of hall-effect sensors, offering different sensing technologies that achieve similar position detection capabilities while accommodating various design constraints or performance requirements.

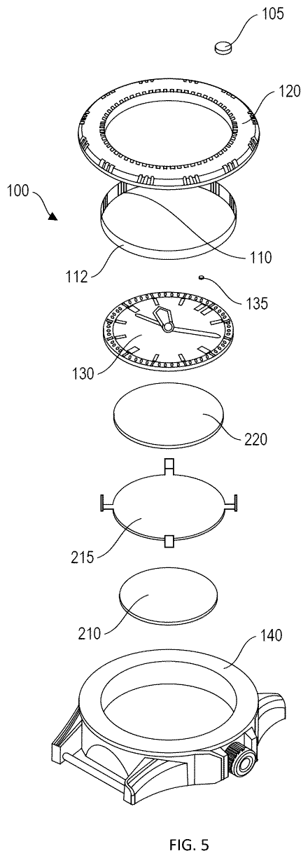

Referring to FIG. 5, the exploded view demonstrates the layered assembly structure that integrates all components within the watch case 140 while maintaining proper magnetic coupling between sensing elements. The rotating bezel 120 includes detents or tactile clicks corresponding to discrete minute increments for user feedback, providing physical confirmation of timer setting positions during bezel rotation. The watch assembly 100 includes a light-emitting diode (LED) visual indicator as part of the alarm actuator system, supplementing the audible and haptic notification methods with visual alerts. The watch case 140 is water-resistant and adapted to house the sensor array 420 without signal interference, ensuring reliable magnetic field detection while protecting internal components from environmental factors.

Alternatively, the system could have a position-detection subsystem configured to determine a relative angular position” without requiring magnetic sensing such as capacitive, optical sensing technologies.

The sensor ring 112 houses the hall effect sensor array 110 are protected from environmental contamination by a barrier that can be made from clear materials such as a polycarbonate, glass, crystal or other suitable material that can be sealed to the watch case 140 and rotating bezel 120. Alternatively, a clear or translucent coating could be applied to the sensor ring 112 and seal the area between the watch case 140 and rotating bezel 120. The coating could be made from an ink formulated from Antimony Tin Oxide (ATO) nanoparticles.

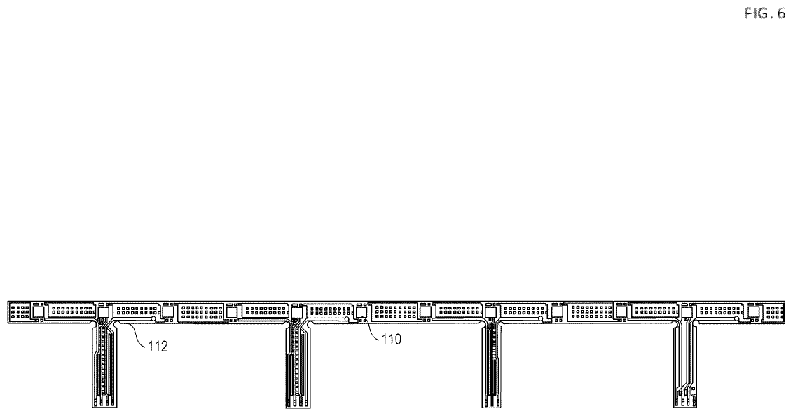

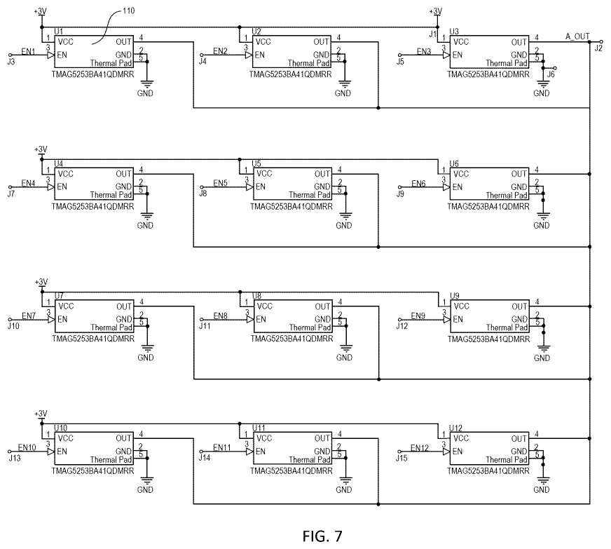

Advanced system features extend the basic timer functionality through wireless connectivity and programmable operation modes. The watch assembly 100 includes wireless synchronization capability such as Bluetooth Low Energy for communication with external smart devices, enabling remote monitoring of timer status and integration with smartphone applications. The microcontroller circuit 420 has updatable firmware via wireless interface for system improvements, allowing software enhancements and feature additions without hardware modifications. As shown in FIG. 6 and FIG. 7, the sensor ring 112 and hall effect sensor array 110 are configured on flexible printed circuit boards that accommodate the circular geometry of the watch assembly 100 while providing reliable electrical connections between individual sensing elements. The rotating bezel timer system is paused and resumed by a secondary bezel rotation gesture, offering user control over timer operation beyond the basic start and stop functions.

Referring to FIG. 1, the watch assembly 100 presents a comprehensive timekeeping device that integrates traditional analog watch functionality with advanced magnetic sensing technology for timer control through bezel-based user interaction. The rotating bezel 120 forms the primary user interface element, positioned as the outermost component of the watch assembly 100 and configured to rotate freely around the watch case 140 to enable timer setting operations. The bezel magnet 105 embeds within the rotating bezel 120 structure to provide a magnetic reference point that interacts with sensing components positioned beneath the watch dial, establishing the foundation for magnetic field detection during timer operations. The crown 115 extends from the side of the watch case 140 to provide standard timekeeping adjustment functionality, while the spring pin 125 secures internal components within the overall assembly structure. The hall effect sensor array 110 positions beneath the watch dial within the sensor ring 112 to detect magnetic field variations as the rotating bezel 120 moves through different angular positions, with the hall effect sensor array 110 comprising twelve hall-effect sensors arranged radially beneath the dial for detecting bezel and minute hand positions.

In an alternate embodiment the system could use an alternative time-indicating element instead of a hall-effect sensor and magnet such as an LED pointer, an LCD element, or another digital indicator.

The clock mechanism 130 drives the standard timekeeping functions while supporting timer functionality through integration with the magnetic sensing system, as shown in FIG. 2. The minute hand magnet 135 integrates into the timekeeping mechanism to provide a secondary magnetic reference point that works in conjunction with the bezel magnet 105 to establish timer countdown operations and alarm triggering conditions. The hall effect sensor array 110 implements on a flexible printed circuit board to fit inside standard watch enclosures, allowing the sensing components to conform to the curved geometry of the watch case 140 while maintaining electrical connectivity between individual sensor elements. The sensor ring 112 houses the hall effect sensor array 110 in a configuration that allows for precise detection of both the bezel magnet 105 position and the minute hand magnet 135 position relative to the watch dial. The hall effect sensor array 110 uses high-sensitivity, low-power hall sensors such as (TMAG5253BA4IQDMRR) for magnetic field detection, enabling precise position determination while minimizing power consumption during operation. However, any suitable low-power hall sensor could be used.

In an alternate embodiment the system could use an alternative time-indicating element instead of a hall-effect sensor and magnet such as an LED pointer, an LCD element, or another digital indicator.

With continued reference to FIG. 2, the electronic control system incorporates the sensor monitoring board 215 that processes signals from the hall effect sensor array 110 and coordinates with the control board 400 to manage overall system operation. A piezoelectric buzzer 210 generates audible alerts when timer conditions are met, providing user notification of countdown completion or alarm activation. The battery 220 powers the entire system, with the battery 220 being a coin-cell battery such as CR1220 to power the system with optimized deep-sleep modes for extended battery life while maintaining continuous operation of the timing and sensing functions. However, any suitable coin-cell battery could be used. The control board 400 coordinates the overall system operation by processing sensor data and managing timer functions through integrated electronic components that interpret magnetic field changes and translate them into timer control commands. The piezoelectric buzzer 210 configures to produce both audible tones and haptic vibration simultaneously, providing multiple forms of user notification when timer events occur. However, in an alternative embodiment the system could also utilize a communication interface configured to transmit notifications to an external device.

In addition to onboard notification systems, such as audible alarms, haptic vibration, or visual indicators, the device may further comprise a communication interface for transmitting notifications to external devices. For example, a Bluetooth, Wi-Fi, NFC, or other wireless communication module may be configured to send a notification signal to a companion smartphone, wearable device, or external system. In some embodiments, the external device may generate the user-facing notification (audible, visual, or haptic) in response to the transmitted signal.

However, in alternative embodiments the coin cell battery 220 can be a power source configured to supply energy, including coin-cell, rechargeable, solar, energy-harvesting, or wired power.

As illustrated in FIG. 4, the microcontroller circuit 420 serves as the central processing unit for the timer system, coordinating sensor data acquisition and alarm activation functions through integrated electronic components. The microcontroller circuit 420 includes a low-power processor such as ARM Cortex-M0+ processor (STM32G031G8U6) with deep-sleep capability for power optimization, allowing the system to operate efficiently within the power constraints of a wristwatch or time keeping device application while maintaining responsive timer functionality. However, any suitable low-power processor could be used. The control board 400 includes a multiplexer such as the (PCA9535AHF) and analog-to-digital converter such as the (ADS1115IRUGR) for sequential sensor reading and data processing, enabling the microcontroller circuit 420 to efficiently monitor multiple sensor inputs without excessive power consumption. However, any suitable multiplexer or analog-to-digital converter could be used. The sensor array 420 represents the collective sensing elements that detect magnetic field variations from both the bezel magnet 105 and the minute hand magnet 135, working in coordination with the microcontroller circuit 420 to establish timer durations and countdown operations. A piezoelectric buzzer 430 connects to the microcontroller circuit 420 to provide audible notification capabilities when timer conditions are satisfied. In alternative embodiments the mode-control can be accomplished using bezel gestures such as switching between seconds/minutes, pause/resume or mode switching.

Referring to FIG. 5, the exploded view demonstrates the layered assembly structure that integrates all components within the watch case 140 while maintaining proper magnetic coupling between sensing elements and reference magnets. The watch assembly 100 includes a vibration motor as an alternative alarm actuator to the piezoelectric buzzer 210, providing silent notification options for discrete timer alerts in situations where audible alarms are not appropriate. The rotating bezel 120 includes multiple magnets distributed along its circumference to provide higher resolution detection, enabling more precise timer setting increments beyond the basic twelve-position configuration established by the hall effect sensor array 110. The hall effect sensor array 110 alternatively comprises optical or magnetic-field gradient sensors instead of hall-effect sensors, offering different sensing technologies that achieve similar position detection capabilities while accommodating various design constraints or performance requirements. The rotating bezel 120 includes detents or tactile clicks corresponding to discrete minute increments for user feedback, providing physical confirmation of timer setting positions during bezel rotation operations.

The watch assembly 100 incorporates advanced functionality features that extend beyond basic timer operation through wireless connectivity and enhanced user interface options. The watch assembly 100 includes a light-emitting diode (LED) visual indicator as part of the alarm actuator system, supplementing the audible and haptic notification methods with visual alerts that provide additional user notification options. The watch case 140 is water-resistant and adapted to house the sensor array 420 without signal interference, ensuring reliable magnetic field detection while protecting internal components from environmental factors that could affect system performance. The watch assembly 100 includes wireless synchronization capability such as Bluetooth Low Energy for communication with external smart devices, enabling remote monitoring of timer status and integration with smartphone applications for enhanced functionality. The microcontroller circuit 420 has updatable firmware via wireless interface for system improvements, allowing software enhancements and feature additions without hardware modifications to the watch assembly 100. As shown in FIG. 6 and FIG. 7, the sensor ring 112 and hall effect sensor array 110 configure on flexible printed circuit boards that accommodate the circular geometry of the watch assembly 100 while providing reliable electrical connections between individual sensing elements. The rotating bezel timer system pauses and resumes by a secondary bezel rotation gesture, offering user control over timer operation beyond the basic start and stop functions available through standard bezel positioning.

While the disclosure documents specific controller and architecture the applicant realizes the system can use a suitable microcontroller and electronics the system can use any detection alignment technology that is suitable between a bezel reference marker and a time-indicating element such as starting a countdown timer, and providing a notification upon expiration,” implemented by a controller and the controller can be configured to manage multiple simultaneous countdown timers.

Referring to FIG. 2, the cross-sectional view reveals the precise internal arrangement of magnetic sensing components and electronic subsystems within the watch assembly 100. The rotating bezel 120 positions at the uppermost layer of the assembly, with the bezel magnet 105 embedded within the rotating bezel 120 structure to establish a magnetic reference point that moves in correspondence with bezel rotation. The sensor ring 112 positions directly beneath the rotating bezel 120 and houses the hall effect sensor array 110 in a radial configuration that enables detection of magnetic field variations as the bezel magnet 105 moves through different angular positions. The hall effect sensor array 110 comprises twelve hall-effect sensors arranged radially beneath the dial for detecting bezel and minute hand positions, with each sensor positioned at thirty-degree intervals to provide discrete sensing points corresponding to minute increments on the timer interface. The sensor monitoring board 215 connects to the hall effect sensor array 110 through electrical pathways that carry sensor signals to processing components, while the control board 400 coordinates overall system operation through integrated electronic circuits.

In an alternate embodiment the system could use an alternative time-indicating element instead of a hall-effect sensor and magnet such as an LED pointer, an LCD element, or another digital indicator.

The clock mechanism 130 occupies the central portion of the watch assembly 100 and drives standard timekeeping functions while supporting timer functionality through magnetic position detection capabilities. The minute hand magnet 135 integrates into the clock mechanism 130 to provide a secondary magnetic reference point that works in conjunction with the bezel magnet 105 to establish timer countdown operations and alarm triggering conditions. The interaction between the bezel magnet 105 and the minute hand magnet 135 creates distinct magnetic field patterns that the hall effect sensor array 110 detects to determine relative positions of both magnetic elements. The hall effect sensor array 110 implements on a flexible printed circuit board to fit inside standard watch enclosures, allowing the sensing components to conform to the curved geometry of the watch case 140 while maintaining electrical connectivity between individual sensor elements. The flexible printed circuit board construction enables the hall effect sensor array 110 to wrap around the internal circumference of the watch case 140 without compromising signal integrity or mechanical stability.

Alternatively, the system could use a plurality of sensors arranged around a dial, implemented on a circuit board (flexible or rigid). Alternatively, the applicant envisions the use of any other method to detect the relative angular position between a rotatable bezel reference marker and a time-indicating element reference marker using one or more of direct sensor measurements, encoder outputs, or inferred signals computed by a controller.

With continued reference to FIG. 2, the electronic subsystems integrate within the lower portion of the watch assembly 100 to provide power management and signal processing capabilities. The battery 220 positions within the watch case 140 and provides electrical power to all electronic components, with the battery 220 being a coin-cell battery such as CR1220 to power the system with optimized deep-sleep modes for extended battery life. However, any suitable coin-cell battery could be used. The piezoelectric buzzer 210 mounts within the watch case 140 to generate audible alerts when timer conditions are met, with the piezoelectric buzzer 210 configured to produce both audible tones and haptic vibration simultaneously through controlled electrical excitation. The sensor monitoring board 215 processes signals from the hall effect sensor array 110 and coordinates with the control board 400 to manage timer functions and alarm activation sequences. The control board 400 includes a multiplexer such as the (PCA9535AHF) and analog-to-digital converter such as the (ADS1115IRUGR) for sequential sensor reading and data processing, enabling efficient monitoring of multiple sensor inputs without excessive power consumption. However, any suitable multiplexer or analog-to-digital converter could be used.

As illustrated in FIG. 4, the microcontroller circuit 420 serves as the central processing unit for magnetic field interpretation and timer control operations. The microcontroller circuit 420 includes a low-power processor such as ARM Cortex-M0+ processor (STM32G031G8U6) with deep-sleep capability for power optimization, allowing the system to operate efficiently within the power constraints of a wristwatch or time keeping device application while maintaining responsive timer functionality. However, any suitable low-power processor could be used. The sensor array 420 represents the collective sensing elements that detect magnetic field variations from both the bezel magnet 105 and the minute hand magnet 135, working in coordination with the microcontroller circuit 420 to establish timer durations and countdown operations. The hall effect sensor array 110 uses high-sensitivity, low-power hall sensors such as (TMAG5253BA4IQDMRR) for magnetic field detection, enabling precise position determination while minimizing power consumption during continuous monitoring operations. However, any suitable low-power hall sensor could be used. The microcontroller circuit 420 processes analog signals from the hall effect sensor array 110 through the analog-to-digital converter, converting magnetic field strength measurements into digital values that represent angular positions of the bezel magnet 105 and the minute hand magnet 135.

Referring to FIG. 5, the exploded view demonstrates the layered assembly structure that maintains proper magnetic coupling between sensing elements while accommodating alternative component configurations. The watch assembly 100 includes a vibration motor as an alternative alarm actuator to the piezoelectric buzzer 210, providing silent notification options for discrete timer alerts through mechanical vibration generation. The rotating bezel 120 includes multiple magnets distributed along its circumference to provide higher resolution detection, enabling more precise timer setting increments beyond the basic twelve-position configuration established by the standard hall effect sensor array 110. The hall effect sensor array 110 alternatively comprises optical or magnetic-field gradient sensors instead of hall-effect sensors, offering different sensing technologies that achieve similar position detection capabilities while accommodating various design constraints or performance requirements. The rotating bezel 120 includes detents or tactile clicks corresponding to discrete minute increments for user feedback, providing physical confirmation of timer setting positions during bezel rotation operations through mechanical engagement mechanisms.

The watch assembly 100 incorporates advanced sensing and communication capabilities that extend beyond basic magnetic field detection through integrated electronic systems. The watch assembly 100 includes a light-emitting diode (LED) visual indicator as part of the alarm actuator system, supplementing the audible and haptic notification methods with visual alerts that provide additional user notification options during timer expiration events. The watch case 140 is water-resistant and adapted to house the sensor array 420 without signal interference, ensuring reliable magnetic field detection while protecting internal components from environmental factors that could affect system performance or accuracy. The sensor ring 112 houses the hall effect sensor array 110 are protected from environmental contamination by a barrier that can be made from clear materials such as a polycarbonate, glass, crystal or other suitable material that can be sealed to the watch case 140 and rotating bezel 120. Alternatively, a clear or translucent coating could be applied to the sensor ring 112 and seal the area between the watch case 140 and rotating bezel 120. The coating could be made from an ink formulated from Antimony Tin Oxide (ATO) nanoparticles.

The watch assembly 100 includes wireless synchronization capability such as Bluetooth Low Energy for communication with external smart devices, enabling remote monitoring of timer status and integration with smartphone applications for enhanced functionality and data logging. The microcontroller circuit 420 has updatable firmware via wireless interface for system improvements, allowing software enhancements and feature additions without hardware modifications to the watch assembly 100 through over-the-air programming capabilities.

As shown in FIG. 6 and FIG. 7, the sensor ring 112 and hall effect sensor array 110 configure on flexible printed circuit boards that accommodate the circular geometry of the watch assembly 100 while providing reliable electrical connections between individual sensing elements. The flexible printed circuit board construction allows the hall effect sensor array 110 to conform to the internal curvature of the watch case 140 while maintaining precise sensor positioning relative to the magnetic reference points. The rotating bezel timer system pauses and resumes by a secondary bezel rotation gesture, offering user control over timer operation beyond the basic start and stop functions available through standard bezel positioning sequences. The hall effect sensor array 110 detects specific rotation patterns of the bezel magnet 105 that correspond to pause and resume commands, enabling advanced timer control through intuitive bezel manipulation techniques that do not interfere with standard timer setting operations.

Alternatively, the system could use a plurality of sensors arranged around a dial, implemented on a circuit board (flexible or rigid). Alternatively, the applicant envisions the use of any other method to detect the relative angular position between a rotatable bezel reference marker and a time-indicating element reference marker using one or more of direct sensor measurements, encoder outputs, or inferred signals computed by a controller.

Referring to FIG. 3, the operational sequence of the watch assembly 100 begins when a user rotates the rotating bezel 120 to establish a desired timer duration through angular displacement of the bezel magnet 105. The rotation of the rotating bezel 120 causes the bezel magnet 105 to move through a series of discrete positions that correspond to minute increments on the timer interface, with each position generating distinct magnetic field patterns detectable by the hall effect sensor array 110. The hall effect sensor array 110 comprises twelve hall-effect sensors arranged radially beneath the dial for detecting bezel and minute hand positions, with each sensor positioned to detect magnetic field variations as the bezel magnet 105 passes through specific angular locations. The sensor ring 112 houses the hall effect sensor array 110 in a configuration that enables continuous monitoring of magnetic field strength and orientation changes during bezel rotation operations. The hall effect sensor array 110 uses high-sensitivity, low-hall sensors such as (TMAG5253BA4IQDMRR) for magnetic field detection, enabling precise angular position determination while maintaining low power consumption during continuous monitoring cycles. However, any suitable low-power hall sensor could be used.

In some embodiments, the relative angular position between the bezel reference marker and the time-indicating element may be determined indirectly by the controller without requiring a dedicated array of discrete position sensors. For example, the controller may infer the bezel angular position by correlating encoder pulse counts, IMU outputs (such as accelerometer or gyroscope data), timing signals from the clock mechanism, or previously recorded sensor signatures. Interpolation, filtering, and sensor-fusion algorithms (e.g., Kalman filtering, moving-average, or other estimation techniques) may be used to estimate bezel alignment with sufficient resolution for timer operation. Such inferred or sensor less approaches may reduce component count while still enabling accurate countdown and notification functionality.

The magnetic field detection process initiates when the hall effect sensor array 110 registers changes in magnetic flux density as the bezel magnet 105 moves relative to individual sensor elements within the sensor ring 112. The control board 400 includes a multiplexer such as the (PCA9535AHF) and analog-to-digital converter such as the (ADS1115IRUGR) for sequential sensor reading and data processing, enabling systematic interrogation of each sensor within the hall effect sensor array 110 without simultaneous activation of all sensing elements. However, any suitable multiplexer or analog-to-digital converter could be used. The multiplexer sequentially connects individual hall sensors to the analog-to-digital converter, which converts analog magnetic field strength measurements into digital values that represent the angular position of the bezel magnet 105. The microcontroller circuit 420 receives these digital values and processes them through algorithmic interpretation routines that determine the exact angular position of the rotating bezel 120 relative to a reference point on the watch dial. The hall effect sensor array 110 implements on a flexible printed circuit board to fit inside standard watch enclosures, allowing the sensing components to conform to the curved internal geometry of the watch case 140 while maintaining electrical connectivity between individual sensor elements and the control board 400.

In alternative embodiments the mode-control can be accomplished using bezel gestures such as pause/resume or mode switching.

With continued reference to FIG. 3, the microcontroller circuit 420 includes a low-power processor such as ARM Cortex-M0+ processor (STM32G031G8U6) with deep-sleep capability for power optimization, enabling efficient processing of sensor data while minimizing power consumption between active sensing cycles. However, any suitable low-power processor could be used. The microcontroller circuit 420 interprets the digital position data from the hall effect sensor array 110 and calculates the timer duration based on the angular displacement of the rotating bezel 120 from a reference position. The system establishes a countdown timer by comparing the current position of the minute hand magnet 135 with the target position indicated by the bezel magnet 105, creating a time differential that represents the countdown duration. The clock mechanism 130 continues to drive the minute hand magnet 135 through its normal timekeeping cycle while the microcontroller circuit 420 monitors the relative positions of both magnetic elements through continuous sampling of the hall effect sensor array 110. The battery 220 being a coin-cell battery such as CR1220 to power the system with optimized deep-sleep modes for extended battery life, allowing the microcontroller circuit 420 to enter low-power states between sensor sampling cycles while maintaining timer functionality. However, any suitable coin-cell battery could be used.

In an alternative embodiment, a single absolute position sensor or encoder may provide the bezel angular position. For example, an absolute magnetic encoder, optical absolute encoder, or capacitive absolute position sensor may output an angular position value that the controller reads to determine timer settings. Mechanical rotary encoders or discrete detent switches may be used to provide lower-cost discrete position detection. The controller may use the absolute or discrete position data directly or in combination with other sensor inputs to determine relative alignment.

In a next preferred embodiment, the controller switches between minutes-countdown mode and seconds-countdown mode based on bezel rotation direction, magnitude, or position

In some embodiments, the countdown timer may be operated at different resolutions, such as a minute mode or a second mode. The controller may determine the operating mode based on bezel input characteristics, such as the direction of rotation (clockwise versus counterclockwise), the magnitude of bezel displacement, the number of bezel detents traversed, or the location of bezel alignment. For example, a clockwise bezel alignment may initiate a minute countdown, while a counterclockwise bezel alignment may initiate a second countdown. Other variations, such as gesture-based input or explicit mode selection via a control interface, may also be employed.

As illustrated in FIG. 4, the sensor array 420 provides continuous magnetic field monitoring capabilities that enable real-time tracking of both the bezel magnet 105 and the minute hand magnet 135 throughout the countdown sequence. The microcontroller circuit 420 processes sensor data through interrupt-driven routines that activate when magnetic field changes exceed predetermined thresholds, indicating movement of either magnetic element within the detection range of the hall effect sensor array 110. The system architecture incorporates predictive algorithms within the microcontroller circuit 420 that anticipate the convergence of the minute hand magnet 135 with the target position established by the bezel magnet 105, enabling precise timing of alarm activation sequences. The control board 400 coordinates data flow between the sensor array 420 and the microcontroller circuit 420 through high-speed digital communication protocols that minimize latency between magnetic field detection and timer status updates. The hall effect sensor array 110 alternatively comprises optical or magnetic-field gradient sensors instead of hall-effect sensors, offering different sensing technologies that achieve similar position detection capabilities while accommodating various design constraints or environmental conditions.

In an alternate embodiment the system could use an alternative time-indicating element instead of a hall-effect sensor and magnet such as an LED pointer, an LCD element, or another digital indicator.

Referring to FIG. 5, the alarm activation sequence begins when the microcontroller circuit 420 determines that the minute hand magnet 135 has reached the angular position previously established by the bezel magnet 105 during timer setting operations. The microcontroller circuit 420 generates control signals that activate the piezoelectric buzzer 210 through pulse-width modulation techniques that produce audible tones with specific frequency and amplitude characteristics. The piezoelectric buzzer 210 configures to produce both audible tones and haptic vibration simultaneously, providing multiple forms of user notification through controlled electrical excitation of the piezoelectric element. The watch assembly 100 includes a vibration motor as an alternative alarm actuator to the piezoelectric buzzer 210, providing silent notification options through mechanical vibration generation when audible alerts are not appropriate for the user environment. The sensor monitoring board 215 continues to process signals from the hall effect sensor array 110 during alarm activation to detect user interaction with the rotating bezel 120 that indicates acknowledgment or dismissal of the timer alert.

The system architecture supports advanced operational modes that extend beyond basic timer functionality through enhanced sensor interpretation and user interface capabilities. The rotating bezel 120 includes multiple magnets distributed along its circumference to provide higher resolution detection, enabling more precise timer setting increments beyond the standard twelve-position configuration established by the basic hall effect sensor array 110. The microcontroller circuit 420 processes magnetic field patterns from multiple bezel magnets to determine sub-minute timer increments, increasing the precision of countdown duration settings through interpolation algorithms that calculate intermediate positions between discrete sensor locations. The rotating bezel 120 includes detents or tactile clicks corresponding to discrete minute increments for user feedback, providing physical confirmation of timer setting positions through mechanical engagement mechanisms that align with the magnetic detection positions. The rotating bezel timer system pauses and resumes by a secondary bezel rotation gesture, offering user control over timer operation through specific rotation patterns that the hall effect sensor array 110 detects as distinct from standard timer setting movements.

In an embodiments, a single absolute position sensor or encoder may provide the bezel angular position. For example, an absolute magnetic encoder, optical absolute encoder, or capacitive absolute position sensor may output an angular position value that the controller reads to determine timer settings. Mechanical rotary encoders or discrete detent switches may be used to provide lower-cost discrete position detection. The controller may use the absolute or discrete position data directly or in combination with other sensor inputs to determine relative alignment.

As shown in FIG. 6 and FIG. 7, the watch assembly 100 incorporates enhanced notification and connectivity features that expand the basic alarm activation capabilities through integrated electronic systems. The watch assembly 100 includes a light-emitting diode (LED) visual indicator as part of the alarm actuator system, supplementing the audible and haptic notification methods with visual alerts that activate simultaneously with the piezoelectric buzzer 210 during timer expiration events. The watch case 140 being water-and or dust resistant and adapted to house the sensor array 420 without signal interference ensures reliable magnetic field detection while protecting internal components from environmental factors that could affect system performance during outdoor or aquatic activities. The sensor ring 112 houses the hall effect sensor array 110 are protected from environmental contamination by a barrier that can be made from clear materials such as a polycarbonate, glass, crystal or other suitable material that can be sealed to the watch case 140 and rotating bezel 120. Alternatively, a clear or translucent coating could be applied to the sensor ring 112 and seal the area between the watch case 140 and rotating bezel 120. The coating could be made from an ink formulated from Antimony Tin Oxide (ATO) nanoparticles.

The watch assembly 100 includes wireless synchronization capability such as Bluetooth Low Energy for communication with external smart devices, enabling remote monitoring of timer status and integration with smartphone applications through data transmission protocols that operate independently of the primary timer functions. The microcontroller circuit 420 has updatable firmware via wireless interface for system improvements, allowing software enhancements and feature additions without hardware modifications to the watch assembly 100 through over-the-air programming capabilities that maintain backward compatibility with existing timer operations.

Referring to FIG. 4, the microcontroller circuit 420 establishes the central processing hub for the watch assembly 100 through a comprehensive electrical architecture that coordinates magnetic field detection, signal processing, and alarm activation functions. The microcontroller circuit 420 includes a low-power processor such as ARM Cortex-M0+ processor (STM32G031G8U6) with deep-sleep capability for power optimization, enabling efficient operation within the power constraints of the watch assembly 100 while maintaining continuous monitoring of the hall effect sensor array 110. However, any suitable low-power processor could be used. The electrical schematic demonstrates interconnections between the microcontroller circuit 420 and the sensor array 420 through digital communication pathways that carry sensor data from individual hall sensors to the central processing unit. The control board 400 includes a multiplexer such as the (PCA9535AHF) and analog-to-digital converter such as the (ADS1115IRUGR) for sequential sensor reading and data processing, establishing a systematic approach to interrogating each sensor within the hall effect sensor array 110 without simultaneous activation of all sensing elements. The piezoelectric buzzer 430 connects directly to the microcontroller circuit 420 through pulse-width modulation output pins that generate controlled electrical signals for audible and haptic notification generation. However, any suitable multiplexer or analog-to-digital converter could be used.

In a next preferred embodiment, the controller switches between minutes-countdown mode and seconds-countdown mode based on a button, bezel rotation direction, magnitude, or position

The signal processing pathways within the control board 400 facilitate the conversion of analog magnetic field measurements into digital position data through a multi-stage electronic interface. The multiplexer such as the (PCA9535AHF) receives control signals from the microcontroller circuit 420 that specify which individual hall sensor within the hall effect sensor array 110 connects to the analog-to-digital converter such as the (ADS1115IRUGR) during each sampling cycle. However, any suitable multiplexer or analog-to-digital converter could be used. The hall effect sensor array 110 uses high-sensitivity, low-power hall sensors such as (TMAG5253BA4IQDMRR) for magnetic field detection, generating analog voltage outputs that correspond to magnetic flux density variations as the bezel magnet 105 and the minute hand magnet 135 move through different angular positions. However, any suitable low-power hall sensor could be used. The analog-to-digital converter (ADS1115IRUGR) processes these analog voltage signals and converts them into 16-bit digital values that represent magnetic field strength measurements with high precision and resolution. The microcontroller circuit 420 receives these digital values through an I2C communication interface that enables high-speed data transfer between the analog-to-digital converter and the central processing unit.

With continued reference to FIG. 4, the power management features within the control board 400 optimize electrical consumption through selective activation of electronic components and deep-sleep operation modes. The battery 220 being a coin-cell battery such as CR1220 to power the system with optimized deep-sleep modes for extended battery life, supplying electrical energy to all electronic components through regulated voltage distribution networks. However, any suitable coin-cell battery could be used. The microcontroller circuit 420 coordinates power management functions by controlling the activation states of the multiplexer 410 such as the (PCA9535AHF) and the analog-to-digital converter 440 such as the (ADS1115IRUGR) through enable signals that activate these components only during active sensor sampling cycles. However, any suitable multiplexer or analog-to-digital converter could be used. The hall effect sensor array 110 receives power through the multiplexer such as the (PCA9535AHF), which selectively energizes individual hall sensors during their respective sampling intervals while maintaining other sensors in low-power standby states. However, any suitable multiplexer could be used.

In an alternative embodiment the system could be designed to implement mechanical/pendulum energy harvesting, piezoelectric, or electromagnetic generation system to charge or replace the battery.

The power distribution network incorporates voltage regulation circuits that maintain stable operating voltages for all electronic components despite variations in battery voltage as the coin-cell battery such as CR1220 will discharge over time. However, as noted the design could use any suitable coin-cell battery. However, in alternative embodiments the coin cell battery 220 can be a power source configured to supply energy, including coin-cell, rechargeable, solar, energy-harvesting, or wired power.

As illustrated in FIG. 5, the electronic interfaces between the sensor monitoring board 215 and the control board 400 establish communication pathways that enable real-time coordination between magnetic field detection and timer control functions. The sensor monitoring board 215 processes initial signal conditioning for the hall effect sensor array 110 through amplification and filtering circuits that enhance signal quality before transmission to the control board 400. The hall effect sensor array 110 implements on a flexible printed circuit board to fit inside standard watch enclosures, with electrical connections between individual sensors routed through flexible copper traces that maintain connectivity while conforming to the curved geometry of the watch case 140. The sensor array 420 connects to the microcontroller circuit 420 through multi-conductor cable assemblies that carry power, ground, and signal lines between the flexible printed circuit board and the control board 400. The electronic interfaces incorporate electromagnetic shielding techniques that prevent interference between the magnetic sensing operations and the digital signal processing functions within the microcontroller circuit 410.

Referring to FIG. 6 and FIG. 7, the hall effect sensor array 110 demonstrates a distributed sensing architecture that enables comprehensive magnetic field detection around the circumference of the watch assembly 100. The hall effect sensor array 110 comprises twelve hall-effect sensors arranged radially beneath the dial for detecting bezel and minute hand positions, with each sensor positioned at thirty-degree intervals to provide discrete sensing points that correspond to minute increments on the timer interface. The flexible printed circuit board construction incorporates individual sensor mounting locations connected through a common electrical bus that distributes power and ground connections to all sensing elements while providing separate signal return paths for each hall sensor. The sensor ring 112 houses the hall effect sensor array 110 in a configuration that positions each hall sensor at optimal distances from the magnetic reference points while maintaining electrical isolation between adjacent sensing elements. The electrical interconnections between individual hall sensors utilize surface-mount technology that minimizes the physical footprint of each sensing element while providing reliable electrical connections that withstand mechanical stress during watch assembly operations.

The electronic architecture supports alternative sensing technologies and enhanced functionality through modular component interfaces that accommodate different sensor types and communication protocols. The hall effect sensor array 110 alternatively comprises optical or magnetic-field gradient sensors instead of hall-effect sensors, with the control board 400 providing configurable input interfaces that adapt to different sensor output characteristics through programmable gain amplifiers and signal conditioning circuits. The watch assembly 100 includes a vibration motor as an alternative alarm actuator to the piezoelectric buzzer 430, connecting to the microcontroller circuit 420 through motor driver circuits that provide controlled electrical power for mechanical vibration generation. The rotating bezel 120 includes multiple magnets distributed along its circumference to provide higher resolution detection, generating complex magnetic field patterns that the hall effect sensor array 110 detects through simultaneous sampling of multiple sensors and subsequent signal processing algorithms within the microcontroller circuit 410. The piezoelectric buzzer 430 is configured to produce both audible tones and haptic vibration simultaneously through dual-mode electrical excitation that generates acoustic waves and mechanical vibrations from the same piezoelectric element.

As shown in FIG. 2, the watch assembly 100 incorporates advanced electronic features that extend beyond basic magnetic sensing through integrated wireless communication and enhanced user interface capabilities. The watch assembly 100 includes wireless synchronization capability such as Bluetooth Low Energy for communication with external smart devices, implementing radio frequency circuits within the control board 400 that operate independently of the magnetic sensing functions while sharing the same power management system. The microcontroller circuit 420 coordinates wireless communication protocols through dedicated radio frequency processing units that transmit timer status information and receive configuration commands from external devices without interrupting the primary magnetic field monitoring operations. The rotating bezel 120 includes detents or tactile clicks corresponding to discrete minute increments for user feedback, with mechanical position sensors that generate electrical signals indicating bezel position changes and transmit these signals to the microcontroller circuit 420 through additional input channels. The watch assembly 100 includes a light-emitting diode (LED) visual indicator as part of the alarm actuator system, connecting to the microcontroller circuit 420 through current-limiting circuits that provide controlled electrical power for visual notification generation during timer expiration events.

With continued reference to FIG. 2, the electronic systems within the watch case 140 incorporate environmental protection features that maintain reliable operation under various operating conditions. The watch case 140 being environmentally sealed to provide dust or water-resistant and adapted to house the sensor array 420 without signal interference incorporates electromagnetic shielding materials that prevent external electromagnetic fields from affecting the magnetic sensing operations while allowing the internal magnetic fields from the bezel magnet 105 and the minute hand magnet 135 to reach the hall effect sensor array 110. The control board 400 utilizes conformal coating materials that protect electronic components from moisture and environmental contaminants while maintaining electrical insulation between adjacent circuit elements. The microcontroller circuit 420 has updatable firmware via wireless interface for system improvements, implementing secure bootloader functions that enable over-the-air programming while preventing unauthorized access to the system firmware. The rotating bezel timer system pauses and resumes by a secondary bezel rotation gesture, with the microcontroller circuit 420 implementing pattern recognition algorithms that distinguish between standard timer setting movements and specific pause/resume command sequences based on the timing and direction of bezel rotation movements detected by the hall effect sensor array 110.

Referring to FIG. 5, the exploded view demonstrates the vertical arrangement and assembly sequence of the watch assembly 100 components, beginning with the rotating bezel 120 positioned at the uppermost layer of the structural hierarchy. The bezel magnet 105 embeds within the rotating bezel 120 structure and establishes the primary magnetic reference point that interacts with sensing components positioned beneath the watch dial during timer operations. The rotating bezel 120 includes multiple magnets distributed along its circumference to provide higher resolution detection, enabling precise angular position determination through enhanced magnetic field patterns that the hall effect sensor array 110 detects during bezel rotation sequences. The rotating bezel 120 includes detents or tactile clicks corresponding to discrete minute increments for user feedback, providing mechanical engagement points that align with the magnetic detection positions and confirm timer setting operations through physical resistance during rotation. The mechanical interface between the rotating bezel 120 and the underlying watch case 140 incorporates bearing surfaces that enable smooth rotation while maintaining precise angular positioning relative to the internal sensing components.

The sensor ring 112 positions directly beneath the rotating bezel 120 and houses the hall effect sensor array 110 in a radial configuration that enables comprehensive magnetic field detection around the circumference of the watch assembly 100. The hall effect sensor array 110 comprises twelve hall-effect sensors arranged radially beneath the dial for detecting bezel and minute hand positions, with each sensor positioned at thirty-degree intervals to provide discrete sensing points that correspond to minute increments on the timer interface. The hall effect sensor array 110 implements on a flexible printed circuit board to fit inside standard watch enclosures, allowing the sensing components to conform to the curved internal geometry of the watch case 140 while maintaining electrical connectivity between individual sensor elements. The hall effect sensor array 110 uses high-sensitivity, low-power hall sensors such as (TMAG5253BA4IQDMRR) for magnetic field detection, generating analog voltage outputs that correspond to magnetic flux density variations as the bezel magnet 105 moves through different angular positions. However, any suitable low-power hall sensor could be used. The flexible printed circuit board construction enables the sensor ring 112 to wrap around the internal circumference of the watch case 140 without compromising signal integrity or mechanical stability during assembly operations.

With continued reference to FIG. 5, the clock mechanism 130 occupies the central portion of the vertical assembly structure and drives standard timekeeping functions while supporting timer functionality through magnetic position detection capabilities. The minute hand magnet 135 integrates into the clock mechanism 130 and provides a secondary magnetic reference point that works in conjunction with the bezel magnet 105 to establish timer countdown operations and alarm triggering conditions. The clock mechanism 130 connects to the crown 115 through mechanical linkages that enable standard time adjustment operations while maintaining the magnetic sensing capabilities of the minute hand magnet 135. The spring pin 125 secures internal components within the overall assembly structure and provides mechanical stability for the clock mechanism 130 during normal operation and environmental stress conditions. The mechanical interface between the clock mechanism 130 and the sensor ring 112 maintains precise clearances that allow the minute hand magnet 135 to move through its timekeeping cycle without interfering with the hall effect sensor array 110 while remaining within the detection range of the magnetic sensing elements.

In alternative embodiments, a single absolute position sensor or encoder may provide the bezel angular position. For example, an absolute magnetic encoder, optical absolute encoder, or capacitive absolute position sensor may output an angular position value that the controller reads to determine timer settings. Mechanical rotary encoders or discrete detent switches may be used to provide lower-cost discrete position detection. The controller may use the absolute or discrete position data directly or in combination with other sensor inputs to determine relative alignment.

The sensor monitoring board 215 positions beneath the clock mechanism 130 and processes initial signal conditioning for the hall effect sensor array 110 through amplification and filtering circuits that enhance signal quality before transmission to the control board 400. The control board 400 coordinates overall system operation through integrated electronic components that interpret magnetic field changes and translate them into timer control commands. The control board 400 includes a multiplexer 410 such as the (PCA9535AHF) and analog-to-digital converter 440 such as the (ADS1115IRUGR) for sequential sensor reading and data processing, enabling systematic interrogation of each sensor within the hall effect sensor array 110 without simultaneous activation of all sensing elements. However, any suitable multiplexer or analog-to-digital converter could be used.

The microcontroller circuit 420 includes a low-power processor such as ARM Cortex-M0+ processor (STM32G031G8U6) with deep-sleep capability for power optimization, allowing the system to operate efficiently within the power constraints of a wristwatch or time keeping device application while maintaining responsive timer functionality. However, any suitable low-power processor could be used. The electrical interconnections between the sensor monitoring board 215 and the control board 400 utilize multi-conductor cable assemblies that carry power, ground, and signal lines while accommodating the mechanical constraints of the watch assembly 100.

In alternative embodiments the controller may implement software routines that process raw sensor or encoder data to determine bezel-to-indicator alignment. Examples include signal conditioning, analog-to-digital conversion, interpolation to estimate intermediate positions between discrete detector outputs, threshold detection, event debouncing, and sensor fusion. Where multiple sensor modalities are present, the controller may weigh and fuse inputs to improve accuracy and reliability under varying environmental conditions.

As illustrated in FIG. 5, the battery 220 positions within the lower portion of the watch case 140 and provides electrical power to all electronic components through regulated voltage distribution networks. The battery 220 being a coin-cell battery such as a CR1220 to power the system with optimized deep-sleep modes for extended battery life, supplying electrical energy to the microcontroller circuit 410, the sensor monitoring board 215, and the hall effect sensor array 110 through coordinated power management functions. However, any suitable coin-cell battery could be used. The piezoelectric buzzer 210 mounts within the watch case 140 adjacent to the battery 220 and generates audible alerts when timer conditions are met through controlled electrical excitation. The piezoelectric buzzer 210 configures to produce both audible tones and haptic vibration simultaneously through dual-mode electrical excitation that generates acoustic waves and mechanical vibrations from the same piezoelectric element. The watch assembly 100 includes a vibration motor as an alternative alarm actuator to the piezoelectric buzzer 210, providing silent notification options through mechanical vibration generation when audible alerts are not appropriate for the user environment.

The watch case 140 forms the structural foundation of the assembly and houses all internal components while maintaining the aesthetic appearance of a traditional analog timepiece. The watch case 140 being environmentally sealed to provide dust or water-resistant and adapted to house the sensor array 420 without signal interference incorporates electromagnetic shielding materials that prevent external electromagnetic fields from affecting the magnetic sensing operations while allowing the internal magnetic fields from the bezel magnet 105 and the minute hand magnet 135 to reach the hall effect sensor array 110. The mechanical design of the watch case 140 incorporates mounting features that secure the sensor ring 112, the clock mechanism 130, the sensor monitoring board 215, and the control board 400 in precise relative positions that enable proper magnetic coupling between sensing elements and reference magnets. The assembly sequence begins with the installation of the control board 400 and the battery 220 within the watch case 140, followed by the mounting of the sensor monitoring board 215 and the establishment of electrical connections between electronic components. The clock mechanism 130 installs above the electronic components with the minute hand magnet 135 positioned to interact with the hall effect sensor array 110 during normal timekeeping operations.

Referring to FIG. 6 and FIG. 7, the hall effect sensor array 110 demonstrates the distributed sensing architecture that integrates with the mechanical assembly structure through flexible printed circuit board construction. The sensor ring 112 houses individual hall sensors at optimal distances from the magnetic reference points while maintaining electrical isolation between adjacent sensing elements through surface-mount technology that minimizes the physical footprint of each sensing element. The hall effect sensor array 110 alternatively comprises optical or magnetic-field gradient sensors instead of hall-effect sensors, with the control board 400 providing configurable input interfaces that adapt to different sensor output characteristics through programmable gain amplifiers and signal conditioning circuits. The flexible printed circuit board incorporates individual sensor mounting locations connected through a common electrical bus that distributes power and ground connections to all sensing elements while providing separate signal return paths for each hall sensor. The electrical interconnections between individual hall sensors utilize copper traces that maintain connectivity while conforming to the curved geometry of the watch case 140 during the assembly process.

With continued reference to FIG. 5, the watch assembly 100 incorporates advanced functionality features that integrate with the mechanical assembly structure through additional electronic components and enhanced user interface elements. The watch assembly 100 includes a light-emitting diode (LED) visual indicator as part of the alarm actuator system, mounting within the watch case 140 to provide visual alerts that supplement the audible and haptic notification methods during timer expiration events. The watch assembly 100 includes wireless synchronization capability such as Bluetooth Low Energy for communication with external smart devices, implementing radio frequency circuits within the control board 400 that operate independently of the magnetic sensing functions while sharing the same power management system. The microcontroller circuit 420 has updatable firmware via wireless interface for system improvements, implementing secure bootloader functions that enable over-the-air programming while preventing unauthorized access to the system firmware. The rotating bezel timer system pauses and resumes by a secondary bezel rotation gesture, with the microcontroller circuit 420 implementing pattern recognition algorithms that distinguish between standard timer setting movements and specific pause/resume command sequences based on the timing and direction of bezel rotation movements detected by the hall effect sensor array 110.

As shown in FIG. 1 and FIG. 2, the completed assembly integrates all components into a functional timekeeping device that combines traditional analog watch functionality with advanced magnetic sensing technology for timer control through bezel-based user interaction. The mechanical relationships between components enable the bezel magnet 105 to move through discrete angular positions that correspond to timer increments while the minute hand magnet 135 continues its normal timekeeping cycle under the control of the clock mechanism 130. The sensor ring 112 maintains the hall effect sensor array 110 in precise alignment with both magnetic reference points throughout the operational cycle, enabling continuous monitoring of magnetic field variations that indicate the relative positions of the bezel magnet 105 and the minute hand magnet 135. The electronic components within the sensor monitoring board 215 and the control board 400 process magnetic field data and coordinate timer functions through integrated circuits that operate within the power constraints established by the battery 220. The watch case 140 provides environmental protection for all internal components while maintaining the mechanical interfaces that enable user interaction with the rotating bezel 120 and the crown 115 for timer setting and timekeeping adjustment operations.

Referring to FIG. 6, the hall effect sensor array 110 demonstrates a linear printed circuit board layout that accommodates the circular installation requirements of the watch assembly 100 through flexible substrate construction. The sensor ring 112 extends from a horizontal base strip in a series of perpendicular projections that create individual mounting locations for each hall effect sensor within the hall effect sensor array 110. The linear arrangement positions twelve individual hall effect sensors along the horizontal strip at predetermined intervals that correspond to the angular spacing requirements when the flexible printed circuit board wraps around the internal circumference of the watch case 140. Each hall effect sensor connects to the horizontal base strip through dedicated copper traces that carry power, ground, and signal connections while maintaining electrical isolation between adjacent sensing elements. The flexible printed circuit board construction enables the transformation from the linear manufacturing layout to the circular operational configuration without compromising electrical connectivity or mechanical integrity of the individual sensor mounting points.

The physical spacing between individual hall effect sensors within the hall effect sensor array 110 establishes thirty-degree angular intervals when the flexible printed circuit board installs within the sensor ring 112 configuration. The hall effect sensor array 110 comprises twelve hall-effect sensors arranged radially beneath the dial for detecting bezel and minute hand positions, with each sensor positioned to detect magnetic field variations from both the bezel magnet 105 and the minute hand magnet 135 as these magnetic elements move through their respective operational cycles. The linear spacing on the flexible printed circuit board calculates to accommodate the circumferential installation within the watch case 140 while maintaining uniform angular distribution of sensing points around the complete 360-degree detection range. The sensor ring 112 provides structural support for the hall effect sensor array 110 during the transformation from linear to circular configuration, with mechanical mounting features that secure each hall effect sensor in precise radial alignment relative to the center axis of the watch assembly 100.

With continued reference to FIG. 6, the electrical interconnections within the hall effect sensor array 110 utilize surface-mount technology that minimizes the physical footprint of each sensing element while providing reliable connections that withstand the mechanical stress of flexible printed circuit board installation. The hall effect sensor array 110 uses high-sensitivity, low-power hall sensors such as (TMAG5253BA4IQDMRR) for magnetic field detection, with each sensor incorporating dedicated power supply connections, ground references, and analog output signals that connect to the common electrical bus through individual copper traces. However, any suitable low-power hall sensor could be used. The flexible printed circuit board incorporates thermal management features through copper pour areas that distribute heat generated by the hall effect sensors during operation while maintaining electrical isolation between signal pathways. The linear layout accommodates automated assembly processes during manufacturing while ensuring that the electrical characteristics remain consistent when the flexible printed circuit board transforms into the circular installation configuration within the sensor ring 112.

As illustrated in FIG. 7, the schematic representation of the hall effect sensor array 110 demonstrates the electrical architecture that supports the physical layout configuration shown in FIG. 6. The twelve hall effect sensors arrange in a matrix configuration with four rows and three columns, providing systematic organization of the sensing elements while maintaining the radial distribution pattern required for circular installation. Each hall effect sensor within the hall effect sensor array 110 connects to common power distribution lines that supply regulated voltage from the battery 220 through the control board 400, while individual signal output lines carry analog voltage measurements to the multiplexer 410 and analog-to-digital converter 440 for sequential processing. The schematic incorporates thermal pad connections for each hall effect sensor that provide heat dissipation pathways through the flexible printed circuit board substrate to the surrounding mechanical structure of the sensor ring 112. The electrical design accommodates the physical constraints of the flexible printed circuit board while ensuring that signal integrity remains consistent across all sensing elements during the circular installation process.

The control board 400 includes a multiplexer 410 such as the (PCA9535AHF) and analog-to-digital converter 440 such as the (ADS1115IRUGR) for sequential sensor reading and data processing, establishing electrical interfaces that accommodate the distributed sensing architecture of the hall effect sensor array 110. However, any suitable multiplexer or analog-to-digital converter could be used. The multiplexer connects to each individual hall effect sensor through dedicated signal lines that route from the circular installation configuration back to the centralized processing components within the control board 400. The flexible printed circuit board construction enables these signal routing requirements through multi-layer copper trace patterns that maintain signal isolation while accommodating the mechanical flexibility needed for circular installation. The analog-to-digital converter 440 receives sequential sensor signals from the multiplexer and converts the analog magnetic field measurements into digital values that the microcontroller circuit 420 processes to determine the angular positions of the bezel magnet 105 and the minute hand magnet 135. The microcontroller circuit 420 includes a low-power processor such as ARM Cortex-M0+ processor (STM32G031G8U6) with deep-sleep capability for power optimization, coordinating the sequential activation of individual hall effect sensors through the multiplexer while maintaining overall system power efficiency. However, any suitable low-power processor could be used.

In certain embodiments, the position of the bezel relative to the watch case or time-indicating element may be determined by an encoder or mechanical detent system. For example, the bezel may be mechanically coupled to a rotary encoder, such as a mechanical contact encoder, an optical encoder, a magnetic absolute encoder, or a capacitive encoder, which produces electrical signals corresponding to bezel angular position. Alternatively, the bezel may be configured with one or more detents, switches, or contact points that provide discrete electrical signals to the controller indicative of bezel angular alignment. Such encoder- or detent-based embodiments may operate independently of or in combination with sensor arrays to provide angular position data.

In alternative embodiments the controller may implement software routines that process raw sensor or encoder data to determine bezel-to-indicator alignment. Examples include signal conditioning, analog-to-digital conversion, interpolation to estimate intermediate positions between discrete detector outputs, threshold detection, event debouncing, and sensor fusion. Where multiple sensor modalities are present, the controller may weigh and fuse inputs to improve accuracy and reliability under varying environmental conditions.

Referring to FIG. 5, the installation process for the hall effect sensor array 110 demonstrates how the linear flexible printed circuit board configuration transforms into the circular operational arrangement within the sensor ring 112. The flexible printed circuit board wraps around the internal circumference of the sensor ring 112 with each hall effect sensor positioning at predetermined angular locations that align with the detection requirements for both the bezel magnet 105 and the minute hand magnet 135. The sensor ring 112 incorporates mechanical mounting features that secure the flexible printed circuit board in the circular configuration while maintaining precise radial alignment of each hall effect sensor relative to the magnetic reference points. The installation process maintains electrical connectivity between the hall effect sensor array 110 and the control board 400 through flexible cable assemblies that accommodate the circular positioning while providing reliable signal transmission pathways. The battery 220 being a coin-cell battery such as CR1220 to power the system with optimized deep-sleep modes for extended battery life, supplying electrical energy to the hall effect sensor array 110 through the power distribution network established within the flexible printed circuit board. However, any suitable coin-cell battery could be used. However, in alternative embodiments the coin cell battery 220 can be a power source configured to supply energy, including coin-cell, rechargeable, solar, energy-harvesting, or wired power.

In some embodiments, the timekeeping device may include an energy-harvesting subsystem configured to convert mechanical energy into electrical energy to at least partially recharge the device's power source. For example, a pendulum, rotor, or oscillating mass may be mechanically coupled to a micro-generator or electromagnetic coil to generate current during user motion, similar to traditional automatic mechanical watches. In other embodiments, piezoelectric transducers, vibration harvesters, or electromagnetic generators driven by bezel rotation or environmental motion may be used. Harvested energy may be stored in a rechargeable cell or capacitor to extend the operating life of the device between battery replacements or charging cycles.

As shown in FIG. 2, the circular installation of the hall effect sensor array 110 within the sensor ring 112 positions each hall effect sensor at optimal distances from both the bezel magnet 105 and the minute hand magnet 135 to ensure reliable magnetic field detection throughout the operational range of the watch assembly 100. The hall effect sensor array 110 alternatively comprises optical or magnetic-field gradient sensors instead of hall-effect sensors, with the flexible printed circuit board construction accommodating different sensor technologies through modular mounting configurations that maintain the same circular installation pattern. The sensor ring 112 houses the hall effect sensor array 110 in a configuration that enables simultaneous detection of magnetic field variations from both magnetic reference points while maintaining electrical isolation between individual sensing elements. The flexible printed circuit board construction accommodates thermal expansion and mechanical stress during normal operation while preserving the precise angular positioning of each sensor relative to the detection targets. The watch case 140 being water-resistant and adapted to house the sensor array 420 without signal interference incorporates electromagnetic shielding materials that protect the hall effect sensor array 110 from external electromagnetic interference while allowing the magnetic fields from the bezel magnet 105 and the minute hand magnet 135 to reach the sensing elements.

With continued reference to FIG. 7, the electrical schematic demonstrates power management features within the hall effect sensor array 110 that coordinate with the overall system power optimization strategies implemented by the microcontroller circuit 410. The hall effect sensor array 110 receives power through selective activation circuits that energize individual sensors only during their respective sampling intervals, reducing overall power consumption while maintaining continuous monitoring capabilities. The flexible printed circuit board incorporates voltage regulation circuits that maintain stable operating conditions for each hall effect sensor despite variations in supply voltage as the battery 220 discharges over time. The schematic shows ground distribution networks that provide stable reference potentials for all sensing elements while minimizing electrical noise that could affect measurement accuracy. The power distribution architecture accommodates the circular installation configuration through redundant power pathways that ensure reliable operation even if individual copper traces experience mechanical stress during the flexible printed circuit board installation process.

The hall effect sensor array 110 supports enhanced functionality through alternative sensor configurations and advanced detection capabilities that extend beyond the basic twelve-sensor arrangement. The rotating bezel 120 includes multiple magnets distributed along its circumference to provide higher resolution detection, generating complex magnetic field patterns that the hall effect sensor array 110 detects through simultaneous sampling of multiple sensors and subsequent signal processing algorithms within the microcontroller circuit 410. The flexible printed circuit board construction accommodates additional sensor mounting locations that enable higher resolution detection through increased sensor density around the circular installation pattern. The watch assembly 100 includes wireless synchronization capability such as Bluetooth Low Energy for communication with external smart devices, with the microcontroller circuit 420 coordinating wireless data transmission of sensor measurements and timer status information through radio frequency circuits that operate independently of the magnetic sensing functions. The microcontroller circuit 420 has updatable firmware via wireless interface for system improvements, enabling software enhancements that optimize sensor sampling algorithms and power management strategies without hardware modifications to the hall effect sensor array 110.

As illustrated in FIG. 1, the completed installation of the hall effect sensor array 110 within the sensor ring 112 integrates seamlessly with the overall mechanical architecture of the watch assembly 100 while maintaining the aesthetic appearance of a traditional analog timepiece. The circular configuration of the hall effect sensor array 110 positions beneath the rotating bezel 120 and enables continuous monitoring of the bezel magnet 105 position as the user rotates the bezel to set timer durations. The sensor ring 112 maintains precise mechanical alignment between the hall effect sensor array 110 and both magnetic reference points throughout the operational cycle, ensuring consistent magnetic field detection accuracy regardless of environmental conditions or mechanical wear. The flexible printed circuit board construction accommodates the assembly tolerances within the watch case 140 while providing reliable electrical connections that support the advanced functionality features of the watch assembly 100. The rotating bezel timer system pauses and resumes by a secondary bezel rotation gesture, with the hall effect sensor array 110 detecting specific rotation patterns through coordinated sampling of multiple sensors that distinguish between standard timer setting movements and pause/resume command sequences.

Referring to FIG. 7, the hall effect sensor array 110 demonstrates a comprehensive electrical schematic that establishes the circuit architecture for the twelve-sensor configuration within the watch assembly 100. The electrical schematic shows twelve individual hall effect sensors arranged in a four-row, three-column matrix pattern that provides systematic organization of sensing elements while maintaining the radial distribution pattern for circular installation within the sensor ring 112. Each hall effect sensor within the hall effect sensor array 110 connects to dedicated power supply lines that distribute regulated voltage from the battery 220 through the control board 400, establishing stable operating conditions for magnetic field detection operations. The hall effect sensor array 110 uses high-sensitivity, low-power hall sensors such as (TMAG5253BA4IQDMRR) for magnetic field detection, with each sensor incorporating individual power (VCC), ground (GND), and analog output (OUT) connections that enable independent operation while sharing common electrical infrastructure. However, any suitable low-power hall sensor could be used. The schematic incorporates thermal pad connections for each hall effect sensor that provide heat dissipation pathways through the flexible printed circuit board substrate to surrounding mechanical structures within the sensor ring 112.

The electrical interconnections within the hall effect sensor array 110 utilize a parallel connection scheme that enables independent sensor operation while sharing common signal lines throughout the circuit architecture. Each hall effect sensor connects to a common power distribution bus that supplies regulated voltage from the battery 220, with individual branch circuits providing dedicated power pathways to each sensing element while maintaining electrical isolation between adjacent sensors. The ground distribution network establishes stable reference potentials for all twelve hall effect sensors through redundant ground pathways that minimize electrical noise and ensure consistent measurement accuracy across the entire sensor array. The analog output connections from each hall effect sensor route through separate signal lines that connect to the control board 400, enabling the multiplexer 410 such as the (PCA9535AHF) to select individual sensors for sequential sampling without interference between sensing elements. However, any suitable multiplexer or analog-to-digital converter 440 could be used. The parallel connection architecture accommodates the flexible printed circuit board construction while ensuring that electrical characteristics remain consistent when the linear manufacturing layout transforms into the circular operational configuration within the sensor ring 112.

Alternatively, the system could use a plurality of sensors arranged around a dial, implemented on a circuit board (flexible or rigid) Alternatively, the applicant envisions the use of any other method to detect the relative angular position between a rotatable bezel reference marker and a time-indicating element reference marker using one or more of direct sensor measurements, encoder outputs, or inferred signals computed by a controller.

With continued reference to FIG. 7, the power management features within the hall effect sensor array 110 coordinate with the overall system power optimization strategies implemented by the microcontroller circuit 410. The battery 220 being a coin-cell battery such as CR1220 to power the system with optimized deep-sleep modes for extended battery life, supplying electrical energy to the hall effect sensor array 110 through voltage regulation circuits that maintain stable operating conditions despite variations in supply voltage during battery discharge cycles. However, any suitable coin-cell battery could be used. The electrical schematic incorporates selective activation circuits that energize individual hall effect sensors only during their respective sampling intervals, reducing overall power consumption while maintaining continuous monitoring capabilities for both the bezel magnet 105 and the minute hand magnet 135. The microcontroller circuit 420 includes a low-power processor such as ARM Cortex-M0+ processor (STM32G031G8U6) with deep-sleep capability for power optimization, coordinating the sequential activation of individual hall effect sensors through control signals that minimize power consumption between active sensing cycles. However, any suitable low-power processor could be used. The power distribution architecture accommodates the circular installation configuration through redundant power pathways that ensure reliable operation even when individual copper traces experience mechanical stress during flexible printed circuit board installation processes.

As illustrated in FIG. 6, the hall effect sensor array 110 implements on a flexible printed circuit board to fit inside standard watch enclosures, with the linear layout accommodating the electrical interconnection requirements shown in the schematic of FIG. 7. The flexible printed circuit board construction incorporates multi-layer copper trace patterns that route power, ground, and signal connections between individual hall effect sensors while maintaining electrical isolation and signal integrity throughout the circuit architecture. The thermal management features within the flexible printed circuit board include copper pour areas that distribute heat generated by the hall effect sensors during operation, working in conjunction with the thermal pad connections shown in the electrical schematic to provide effective heat dissipation pathways. The surface-mount technology utilized for hall effect sensor installation minimizes the physical footprint of each sensing element while providing reliable electrical connections that withstand mechanical stress during the transformation from linear manufacturing layout to circular operational configuration. The electrical design accommodates automated assembly processes during manufacturing while ensuring that the parallel connection scheme remains functional when the flexible printed circuit board wraps around the internal circumference of the sensor ring 112.

Alternatively, the system could use a plurality of sensors arranged around a dial, implemented on a circuit board (flexible or rigid). Alternatively, the applicant envisions the use of any other method to detect the relative angular position between a rotatable bezel reference marker and a time-indicating element reference marker using one or more of direct sensor measurements, encoder outputs, or inferred signals computed by a controller.

Referring to FIG. 4, the control board 400 includes a multiplexer such as the (PCA9535AHF) and analog-to-digital converter 440 such as the (ADS1115IRUGR) for sequential sensor reading and data processing, establishing the interface architecture that coordinates with the parallel connection scheme of the hall effect sensor array 110. However, any suitable multiplexer or analog-to-digital converter could be used.

The multiplexer receives individual signal lines from each hall effect sensor and provides sequential connection of sensing elements to the analog-to-digital converter 440 through controlled switching operations managed by the microcontroller circuit 410. The analog-to-digital converter 440 processes analog voltage outputs from individual hall effect sensors and converts magnetic field strength measurements into 16-bit digital values that represent the angular positions of the bezel magnet 105 and the minute hand magnet 135 with high precision and resolution. The electrical interface between the hall effect sensor array 110 and the control board 400 utilizes multi-conductor cable assemblies that carry the parallel signal lines from the circular installation configuration to the centralized processing components while maintaining signal isolation and electrical integrity. The microcontroller circuit 420 coordinates the sequential sampling operations through I2C communication protocols that enable high-speed data transfer between the analog-to-digital converter 440 and the central processing unit while minimizing power consumption during sensor interrogation cycles.

With continued reference to FIG. 7, the electrical schematic demonstrates alternative sensor configurations that extend the basic twelve-sensor arrangement through enhanced detection capabilities and different sensing technologies. The hall effect sensor array 110 alternatively comprises optical or magnetic-field gradient sensors instead of hall-effect sensors, with the parallel connection scheme accommodating different sensor output characteristics through configurable interface circuits that adapt to various sensing technologies. The electrical architecture supports additional sensor mounting locations that enable higher resolution detection through increased sensor density around the circular installation pattern, with the parallel connection scheme scaling to accommodate additional sensing elements without compromising the power management or signal processing capabilities. The rotating bezel 120 includes multiple magnets distributed along its circumference to provide higher resolution detection, generating complex magnetic field patterns that the hall effect sensor array 110 detects through simultaneous sampling of multiple sensors coordinated by the microcontroller circuit 410. The flexible printed circuit board construction accommodates these alternative configurations through modular mounting arrangements that maintain the same electrical interconnection architecture while supporting different sensor technologies and enhanced functionality features.

As shown in FIG. 2, the installation of the hall effect sensor array 110 within the sensor ring 112 maintains the electrical interconnections established in the schematic while positioning each sensor at optimal distances from both the bezel magnet 105 and the minute hand magnet 135. The circular configuration preserves the parallel connection scheme through flexible copper traces that accommodate the geometric transformation from the linear layout to the radial installation pattern without compromising electrical connectivity or signal integrity. The watch case 140 being environmentally sealed to provide dust or water-resistant and adapted to house the sensor array 420 without signal interference incorporates electromagnetic shielding materials that protect the electrical circuits within the hall effect sensor array 110 from external electromagnetic interference while allowing magnetic fields from the reference magnets to reach the sensing elements. The sensor monitoring board 215 processes initial signal conditioning for the hall effect sensor array 110 through amplification and filtering circuits that enhance signal quality before transmission to the control board 400, working in coordination with the parallel connection architecture to maintain measurement accuracy across all twelve sensing elements. The electrical connections between the hall effect sensor array 110 and the sensor monitoring board 215 utilize the same multi-conductor pathways that support the parallel connection scheme while accommodating the mechanical constraints of the circular installation within the watch assembly 100.

Referring to FIG. 5, the electrical integration of the hall effect sensor array 110 within the overall system architecture demonstrates how the parallel connection scheme coordinates with advanced functionality features and alternative component configurations. The watch assembly 100 includes a vibration motor as an alternative alarm actuator to the piezoelectric buzzer 210, with the electrical architecture accommodating additional actuator circuits that operate independently of the magnetic sensing functions while sharing the same power distribution network established for the hall effect sensor array 110. The watch assembly 100 includes wireless synchronization capability such as Bluetooth Low Energy for communication with external smart devices, implementing radio frequency circuits within the control board 400 that coordinate with the sensor sampling operations without interfering with the parallel connection scheme of the hall effect sensor array 110. The piezoelectric buzzer 210 configures to produce both audible tones and haptic vibration simultaneously through dual-mode electrical excitation circuits that connect to the microcontroller circuit 420 through dedicated output channels separate from the sensor signal pathways. The watch assembly 100 includes a light-emitting diode (LED) visual indicator as part of the alarm actuator system, connecting to the microcontroller circuit 420 through current-limiting circuits that provide controlled electrical power for visual notification generation during timer expiration events.

With continued reference to FIG. 5, the electrical schematic supports enhanced user interface features through additional sensing and feedback mechanisms that integrate with the parallel connection architecture of the hall effect sensor array 110. The rotating bezel 120 includes detents or tactile clicks corresponding to discrete minute increments for user feedback, with mechanical position sensors generating electrical signals that connect to additional input channels within the microcontroller circuit 420 through separate signal pathways that operate independently of the magnetic field detection circuits. The microcontroller circuit 420 has updatable firmware via wireless interface for system improvements, implementing secure bootloader functions that enable over-the-air programming while maintaining the electrical integrity of the hall effect sensor array 110 and the parallel connection scheme during firmware update operations. The rotating bezel timer system pauses and resumes by a secondary bezel rotation gesture, with the microcontroller circuit 420 implementing pattern recognition algorithms that process sensor data from the hall effect sensor array 110 through the existing parallel connection architecture to distinguish between standard timer setting movements and specific pause/resume command sequences. The electrical architecture accommodates these advanced features through the flexible design of the control board 400 and the scalable nature of the parallel connection scheme within the hall effect sensor array 110.

The timekeeping device can further be described as a timekeeping device, comprising:
a. a rotatable bezel including a magnetic reference marker;
b. a Watch Minute Hand Including a Miniature Magnetic Marker;
c. a sensor array comprising a plurality of hall-effect sensors disposed radially beneath a dial;
d. a microcontroller configured to interpret relative positions of said bezel and minute hand; and
e. an alarm actuator configured to trigger upon alignment of the bezel reference and the minute hand.

The timekeeping device as disclosed, wherein the microcontroller operates in a low-power deep-sleep mode between sensor readings.

The timekeeping device as disclosed, wherein the sensor array comprises twelve hall-effect sensors on a flexible printed circuit board.

The timekeeping device as disclosed, wherein the flexible printed circuit board is configured to wrap around an internal circumference of a watch case.

The timekeeping device as disclosed, wherein the alarm actuator is a piezoelectric transducer.

The timekeeping device as disclosed, wherein the piezoelectric transducer is configured to produce both audible tones and haptic vibration simultaneously.

The timekeeping device as disclosed, wherein the microcontroller further comprises an analog-to-digital converter and multiplexer for sequential activation of the hall-effect sensors.

A wristwatch or time keeping device timer system, comprising:
a. a watch case housing a clock mechanism;
b. a rotating bezel mounted on the watch case and including a bezel magnet;
c. a minute hand driven by the clock mechanism and including a minute hand magnet;
d. a flexible printed circuit board positioned within the watch case and comprising twelve hall-effect sensors arranged in a circular pattern;
e. a microcontroller circuit including a multiplexer and analog-to-digital converter for sequential activation of the hall-effect sensors; and
f. a piezoelectric buzzer configured to generate an audible alert when the minute hand magnet aligns with the bezel magnet.

However, the disclosure is in the format of a wristwatch and suitable timekeeping device could be substituted for the wristwatch configuration.

The wristwatch timer system as disclosed, wherein the microcontroller circuit includes a low-power ARM Cortex-M0+ processor with deep-sleep capability for power optimization.

The wristwatch timer system as disclosed, wherein the processor operates in deep-sleep mode between sensor readings to extend battery life.

The wristwatch timer system as disclosed, wherein the watch case is water-resistant and adapted to house the flexible printed circuit board without signal interference.

The wristwatch timer system as disclosed, wherein the rotating bezel includes detents corresponding to discrete minute increments for tactile user feedback.

The wristwatch timer system as disclosed, further comprising a coin-cell battery positioned within the watch case for powering the microcontroller circuit and hall-effect sensors.

The wristwatch or time keeping device timer system as disclosed, wherein the coin-cell battery is configured to operate with optimized deep-sleep modes for extended battery life. In an alternative embodiment the system could be designed to implement mechanical/pendulum energy harvesting, piezoelectric, or electromagnetic generation system to charge or replace the battery. Alternatively, the applicant envisions a power source configured to supply energy, including coin-cell, rechargeable, solar, energy-harvesting, or wired power.

A magnetic sensing watch, comprising:
a. a rotatable bezel with an embedded magnet positioned at a reference location;
b. a timekeeping mechanism including a minute hand with an integrated magnet;
c. a hall-effect sensor array positioned to detect magnetic field variations from both the bezel magnet and the minute hand magnet;
d. a low-power microcontroller configured to process sensor data and determine relative magnetic positions; and
e. an actuator system configured to provide notification when a predetermined alignment condition is detected between the bezel magnet and the minute hand magnet.

The magnetic sensing watch as disclosed, wherein the hall-effect sensor array comprises twelve hall-effect sensors arranged radially beneath a dial at thirty-degree intervals.

The magnetic sensing watch as disclosed, wherein the hall-effect sensors are mounted on a flexible printed circuit board configured to wrap around an internal circumference of a watch case.

The magnetic sensing watch as disclosed, wherein the low-power microcontroller includes a processor with deep-sleep capability for power optimization.

The magnetic sensing watch as disclosed, wherein the microcontroller operates in deep-sleep mode between sensor readings and includes a multiplexer and analog-to-digital converter 440 for sequential activation of the hall-effect sensors.

The magnetic sensing watch as disclosed, wherein the actuator system comprises a piezoelectric buzzer configured to produce both audible tones and haptic vibration simultaneously when the predetermined alignment condition is detected.

The system can alternatively be configured to utilize and variation of technologies such as:
a. Encoder-based and mechanical-detent embodiments for position detection.
b. Energy-harvesting embodiments (pendulum, micro-generator, piezo, etc.).
c. Mode switching between minutes and seconds.
d. User input via bezel, crown, touch ring, or touchscreen.
e. Notifications via external device communication.
f. Multiple Simultaneous Timers.

Certain embodiments may include a controller configured to manage multiple simultaneous countdown timers. For example, the controller may permit a user to establish two or more timers corresponding to different bezel reference alignments, different hand indicators, or different digital display modes. The controller may store and monitor these timers concurrently and trigger one or more notifications as each timer expires.

Referring now to the drawings FIG. 1-8, and more particularly to FIG. 1, there is shown a perspective view of a rotating bezel timer watch assembly, according to aspects of the present disclosure. The following parts can be seen and their relationship to the overall operation of the watch. Rotating Bezel Timer Watch 100, has Rotating bezel 120, Bezel magnet 105, Minute hand magnet 135, spring pin 125, stem or winder 115, Sensor ring 112, Hall effect sensors 110, clock mechanism 130, watch base 140. The spring pin 125 is designed to attach the Rotating Bezel Timer Watch 100 to a standard strap or watch band.

FIG. 2 illustrates a cross-sectional view of the watch assembly of FIG. 1 showing Rotating Bezel Timer Watch 100 having bezel magnets 105 and hall-effect sensor array or sensor ring 112 placement, according to an embodiment. Also shown is Rotating bezel 120, Minute hand magnet 135, Hall effect sensors 110, clock mechanism 130, watch base 140, Piezoelectric buzzer 210, sensor monitoring PCN 215, battery 220, Control PCB 400

FIG. 3 illustrates a block diagram architecture showing an operational sequence of the rotating bezel timer watch, according to aspects of the present disclosure. The user rotates the bezel to the desired timer position step 310. Hall-effect sensor detects location of magnet step 320; the microprocessor interprets alignment and starts alarm count down step 330 and the when timer expires the Microprocessor triggers alarm actuator Step 340.

FIG. 4 illustrates a circuit schematic overview showing electrical interconnections between components of the bezel timer watch, according to an embodiment. The circuit schematic shows microcontroller circuit 420, multiplexer 410, the analog-to-digital converter 440 and buzzer 430.

FIG. 5 shows an exploded view of the watch assembly of FIG. 1, according to aspects of the present disclosure. The view shows the relationship of how the Rotating Bezel Timer Watch 100 is formed from the following parts has Rotating bezel 120, Bezel magnet 105, Minute hand magnet 135, spring pin 125, stem or winder 115, sensor ring 112, hall effect sensors 110, clock mechanism 130, watch base 140, piezoelectric buzzer 210, sensor monitoring PCN 215 and battery 220.

FIG. 6 shows a PCB layout for a sensor array configuration, according to an embodiment. It shows the relationship between sensor ring 112 and hall effect sensors 110.

FIG. 7 illustrates the schematic of the sensor array flex PCB, according to aspects of the present disclosure showing hall effect sensor 110.

The instant invention addresses the problem of Cloud Vulnerabilities and Mobile Device Vulnerabilities. By creating a system that allows access to the systems while ensuring that the devices interacting with the system are sanctioned and allowed to use the system. The instant invention has two methods it can employ to solve the authorized connection problem which is at the heart of any Cloud Vulnerabilities and Mobile Device Vulnerabilities issues. It can use a Global Positioning System (GPS) location filter or an Internet Protocol (IP) address (IP address) filter that allows only those devices that either are from the correct or allowed GPS locations or have the correct IP address. The system can use these filters either individually or in combination to limit access to the system. The system use of these security measures results in a system that can only be implemented with a dedicated network of computerized devices. That network comprises of a cloud server or equivalent system and remote sanctioned smart devices that have either a validated IP address or are located in a sanctioned location that is verified by the GPS location.

Another way of ensuring security is to put the user application on a dedicated device that is limited to using only the memorial system. This prevents access by users without the sanctioned system. The sanctioned devices could be limited by their Internet protocol (IP)address and the system checks the IP address to ensure it is in the sanctioned device file on the system and if the IP address is in the sanctioned device file then the system allows access to the cloud system. This protects the data stored on the cloud system from being maliciously tampered with.

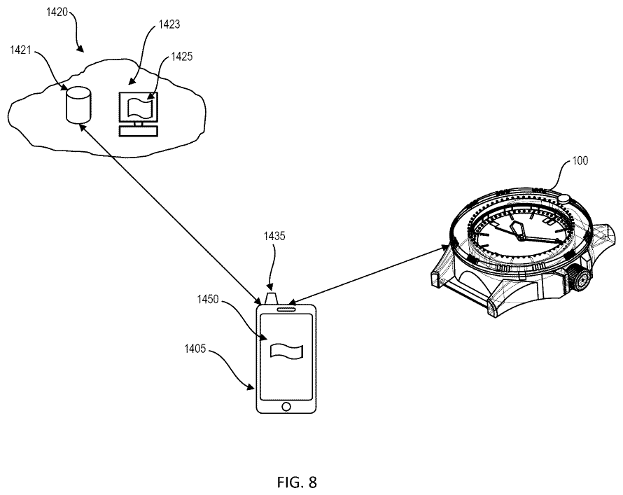

FIG. 8 depicts the system architecture, showing the cloud storage interface and cloud network 1420, which connects to a data storage system 1421 and the Rotating Bezel Timer Watch 100. The cloud network 1420 runs a control program that interfaces with the data storage system 1421 and cloud processor 1423 running cloud application 1425. The GPS module 1435 is used by the user device 1405 and it communicates with the access control program 1450 which will only allow access to the cloud storage interface and cloud network 1420 if the GPS information transmitted from the user device 1405 is contained in a sanctioned GPS location list or if the IP address of the user device 1405 is in a sanctioned IP address list and communications are allowed between 100 and user device 1405.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A timekeeping device, comprising:
a rotatable bezel including a reference marker;
a time-indicating element including a second reference marker;
a position-detection subsystem configured to determine a relative angular position;
a microcontroller configured to interpret relative positions of said bezel and minute hand; and
an alarm actuator configured to trigger upon alignment of the bezel reference and the minute hand.

2. The timekeeping device of claim 1, wherein the microcontroller operates in a low-power deep-sleep mode between sensor readings.

3. The timekeeping device of claim 1, wherein the sensor array comprises hall-effect sensors.

4. The timekeeping device of claim 3, wherein the hall-effect sensors are part of a flexible printed circuit board and the flexible printed circuit board is configured to wrap around an internal circumference of a watch case.

5. The timekeeping device of claim 1, wherein the alarm actuator is a notification system is selected from the group consisting of a piezoelectric transducer, an audible, a haptic, a visual and a communication-based alerts.

6. The timekeeping device of claim 5, wherein the piezoelectric transducer is configured to produce both audible tones and haptic vibration simultaneously.

7. The timekeeping device of claim 1, wherein the microcontroller further comprises an analog-to-digital converter and multiplexer for sequential activation of the hall-effect sensors.

8. A wristwatch timer system, comprising:
a watch case housing a clock mechanism;
a rotating bezel mounted on the watch case and including a bezel magnet;
a minute hand driven by the clock mechanism and including a minute hand magnet;
a flexible printed circuit board positioned within the watch case and comprising a plurality of sensors arranged around a dial in a circular pattern;
a microcontroller circuit including a multiplexer and analog-to-digital converter for sequential activation of the hall-effect sensors; and
a piezoelectric buzzer configured to generate an audible alert when the minute hand magnet aligns with the bezel magnet.

9. The wristwatch timer system of claim 8, wherein the microcontroller circuit has a deep-sleep capability for power optimization.

10. The wristwatch timer system of claim 9, wherein the processor operates in deep-sleep mode between sensor readings to extend battery life.

11. The wristwatch timer system of claim 8, wherein the watch case is water-resistant and adapted to house the flexible printed circuit board without signal interference.

12. The wristwatch timer system of claim 8, wherein the rotating bezel includes detents corresponding to discrete minute increments for tactile user feedback.

13. The wristwatch timer system of claim 8, wherein the plurality of sensors are selected from the group comprising of hall-effect sensors, capacitive, optical, encoder-based, or other sensing methods.

14. The wristwatch timer system of claim 13, wherein the coin-cell battery configured to operate with optimized deep-sleep modes for extended battery life.

15. A magnetic sensing watch, comprising:
a rotatable bezel with an embedded magnet positioned at a reference location;
a timekeeping mechanism including a minute hand with an integrated magnet;
a hall-effect sensor array positioned to detect magnetic field variations from both the bezel magnet and the minute hand magnet;
a low-power microcontroller configured to process sensor data and determine relative magnetic positions; and
an actuator system configured to provide notification when a predetermined alignment condition is detected between the bezel magnet and the minute hand magnet.

16. The magnetic sensing watch of claim 15, wherein the hall-effect sensor array comprises twelve hall-effect sensors arranged radially beneath a dial at thirty-degree intervals.

17. The magnetic sensing watch of claim 16, wherein the hall-effect sensors are mounted on a flexible printed circuit board configured to wrap around an internal circumference of a watch case.

18. The magnetic sensing watch of claim 15, wherein the low-power microcontroller has a deep-sleep capability for power optimization.

19. The magnetic sensing watch of claim 18, wherein the microcontroller operates in deep-sleep mode between sensor readings and includes a multiplexer and analog-to-digital converter for sequential activation of the hall-effect sensors.

20. The magnetic sensing watch of claim 15, wherein the actuator system comprises a piezoelectric buzzer configured to produce both audible tones and haptic vibration simultaneously when the predetermined alignment condition is detected.
